(19) United States
(12) Patent Application Publication
(10) Pub. No.: US 2009/0322104 A1
(43) Pub. Date: Dec. 31, 2009

(54) Door Latch Apparatus for Vehicles

(75) Inventor: Jin Woo NAM, Hwaseong-si (KR)

Correspondence Address: MORGAN, LEWIS & BOCKIUS LLP (SF), One Market, Spear Street Tower, Suite 2800, San Francisco, CA, 94105, US

(73) Assignee: Hyundai Motor Company, Seoul (KR)

(21) Appl. No.: 12/337,199

(22) Filed: Dec. 17, 2008

(30) Foreign Application Priority Data
Jun. 25, 2008 (KR) 10-2008-0060468

(51) Int. Cl. E05C 3/16

(52) U.S. Cl. 292/216

(57) ABSTRACT

A door latch apparatus for vehicles may include a base plate, a claw lever, a pawl lever to selectively restrict the claw lever, the claw lever rotated by an entrance of a striker, a connection lever pivotally coupled to a door lock switch rod, an outside handle lever being coupled to and operated by an outside handle rod. The outside handle lever may include an open lever, a locking link pivotally coupled to the connection lever and slidably coupled to a second end of he outside handle lever and selectively engaged with the open lever of the outside handle lever, a pawl rod hinged to the pawl lever, and an unlocking rod coupled to the other end of the pawl rod and engaged with the other end of the locking link, the unlocking rod being hinged at a medial portion thereof to third position of the base plate.

### CROSS-REFERENCE TO RELATED APPLICATIONS

The present application claims priority to Korean Patent Application Number 10-2008-006468 filed Jun. 25, 2008, the entire contents of which application is incorporated herein for all purposes by this reference.

### BACKGROUND OF THE INVENTION

1. Field of the Invention

The present invention relates to a door latch apparatus for vehicles which is constructed such that even though a vehicle door is closed in a locked state, the vehicle door can be automatically unlocked.

2. Description of Related Art

Generally, to open a door for vehicles, an outside handle is provided on the outer surface of the door, and an inside handle is provided on the inner surface of the door. The outside handle or the inside handle operates a door latch to open the door which is in a closed state. The door latch is provided in the door and functions to maintain a locked state of the door using a door lock switch.

For example, when the outside handle is pulled, a pawl lever of the door latch is rotated by the actuation of an outside handle lever, releasing the pawl lever from a claw lever. However, when a vehicle key is left in the passenger compartment and a user gets out of the vehicle and mistakenly closes the door which is in the locked state, the user cannot open the door again because the door is in the locked state.

### BRIEF SUMMARY OF THE INVENTION

Various aspects of the present invention are directed to provide a door latch apparatus for vehicles which is constructed such that even though a user closes a vehicle door in a locked state, the vehicle door can be automatically unlocked.

In an aspect of the present invention, a door latch apparatus for vehicles may include a pawl lever hinged to a base plate to restrict a claw lever, the claw lever being rotated by an entrance of a striker, a connection lever hinged to the base plate, the connection lever being rotated by an operation of a door lock switch rod, an outside handle lever hinged to the base plate, the outside handle lever being rotated by an operation of an outside handle rod, a locking link connected between the connection lever and the outside handle lever to releasably lock the pawl lever, a pawl rod hinged at a first end thereof to the pawl lever, and/or an unlocking rod coupled at a first end thereof to a second end of the pawl rod, the unlocking rod being hinged at a medial portion thereof to the base plate.

The door latch apparatus for vehicles may further include an open lever hinged to the base plate, the open lever being pushed and rotated by the locking link to release the claw lever from the pawl lever. When the pawl lever is rotated by the claw lever, the second end of the pawl rod pushes the first end of the unlocking rod, so that a second end of the unlocking rod is rotated, thus moving the locking link to an unlocked position.

A first end of the locking link may be hinged to the connection lever, and a second end of the locking link may be coupled to the outside handle lever so as to be movable upwards or downwards.

A first guide slot may be formed through the first end of the unlocking rod so that the second end of the pawl rod is movable along the first guide slot in a longitudinal direction of the unlocking rod.

A second guide slot may be formed through the outside handle lever to guide movement of a hinge shaft of the pawl rod when the pawl lever is rotated.

In another aspect of the present invention, a door latch apparatus for vehicles may include a base plate, a claw lever pivotally coupled to the base plate at first position, a pawl lever pivotally coupled to the base plate at second position to selectively restrict rotation of the claw lever, the claw lever being rotated by an entrance of a striker, a connection lever, one end of which is pivotally coupled to the first position of the base plate and the other end of which is pivotally coupled to a door lock switch rod, the connection lever being rotated by an operation of the door lock switch rod, an outside handle lever pivotally coupled to the second position, one end of the outside handle lever being coupled to and operated by an outside handle rod, wherein the outside handle lever includes an open lever, a locking link, one end of which is pivotally coupled to the connection lever at a medial position thereof and the other end of which is slidably coupled to a second end of the outside handle lever, wherein the other end of the locking link is selectively engaged with the open lever of the outside handle lever to unlock the pawl lever, a pawl rod hinged at one end thereof to the pawl lever, and/or an unlocking rod, one end of which is coupled to the other end of the pawl rod and the other end of which is engaged with the other end of the locking link, the unlocking rod being hinged at a medial portion thereof to third position of the base plate.

The pawl lever may be elastically biased toward the crawl lever by an elastic member.

The outside handle lever may be elastically supported by an elastic member to maintain the original position thereof.

The locking link may include a locking pin at medial position thereof to selectively lock the pawl lever according to position of the locking link.

When the pawl lever is rotated by the claw lever, the other end of the pawl rod may push the one end of the unlocking rod, so that the other end of the unlocking rod is rotated, thus moving the other end of the locking link to be engaged with the open lever to form an unlocked position.

A first guide slot may be formed on the one end of the unlocking rod so that the other end of the pawl rod is slidably movable along the first guide slot in a longitudinal direction thereof.

A second guide slot may be formed through the second end of the outside handle lever to receive the other end of the locking link.

The methods and apparatuses of the present invention have other features and advantages which will be apparent from or are set forth in more detail in the accompanying drawings, which are incorporated herein, and the following Detailed Description of the Invention, which together serve to explain certain principles of the present invention.

### BRIEF DESCRIPTION OF THE DRAWINGS

FIG. 1 is a view illustrating an exemplary door latch apparatus for vehicles according to the present invention.

FIG. 2 is an enlarged view showing the construction of an exemplary pawl rod and unlocking rod of the door latch apparatus according to the present invention.

FIG. 3A is a view showing the operation of the door latch apparatus when a vehicle door is in an open state according to an exemplary embodiment of the present invention.

FIG. 3B is a view showing the operation of the door latch apparatus when the vehicle door is being closed according to an exemplary embodiment of the present invention.

FIG. 3C is a view showing the operation of the door latch apparatus when the vehicle door is in a closed state according to an exemplary embodiment of the present invention.

### DETAILED DESCRIPTION OF THE INVENTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

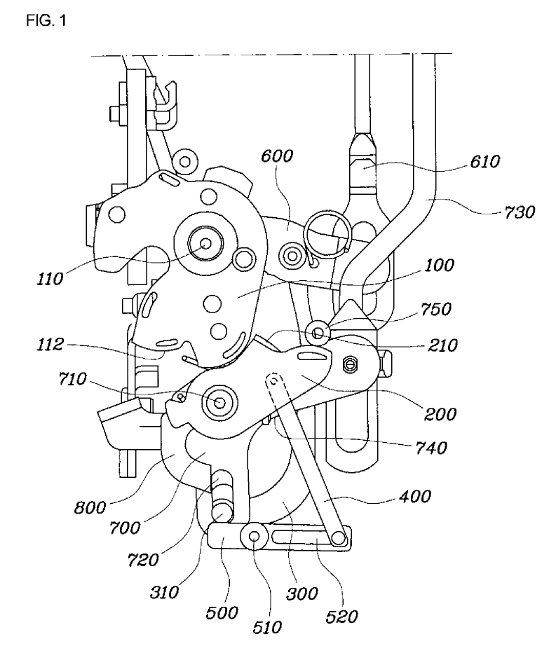

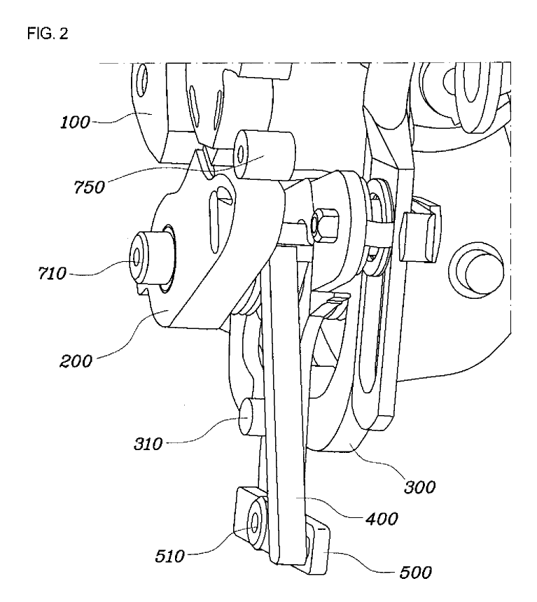

As shown in FIGS. 1 and 2, a door latch apparatus for vehicles according to various embodiments of the present invention is characterized in that a pawl rod 400 and an unlocking rod 500 are operated in conjunction with the operation of a pawl lever 200 such that when a vehicle door is closed in a locked state, a locking link 300 is moved to unlock the door. Therefore, even if a user places a vehicle key in the passenger compartment and closes the door which is in the locked state, the door can be prevented from being undesirably locked.

To achieve the above purpose, according to various embodiments of the present invention, a claw lever 100 and a connection lever 600, which are rotatably coupled to a first rotating shaft 110, are provided on a first portion of a base plate. A pawl lever 200 and an outside handle lever 700, which are rotatably coupled to a second rotating shaft 710, are provided on a second portion of the base plate.

The base plate designates a support bracket for supporting the above-mentioned elements thereon.

In particular, an unlocking rod 500 are hinged to the third portion of the base plate in order to move a locking link 300 to an unlocked position when the vehicle door is closed in the locked state as explained hereinafter.

In detail, the claw lever 100 has a latch notch 111, into which a striker is removably inserted. The claw lever 100 is rotatably mounted to the base plate by the first rotating shaft 110.

The claw lever 100 further includes a holding notch 112 and the pawl lever 200 includes a holding protrusion 210. The pawl lever 200 is elastically biased toward the claw lever 100 by a pawl lever returning spring such as torsion spring. In this configuration, the striker, which is inserted into the latch notch 111, can be locked to the claw lever 100 while the holding protrusion 210 of the pawl lever 200 is held in the holding notch 112 of the claw lever 100.

The connection lever 600 is also rotatably mounted to the first portion of the base plate by the first rotating shaft 110. A door lock switch rod 610 is coupled to the connection lever 600 so that a user can lock or unlock the door by pushing down or pulling up the door lock switch rod 610.

The connection lever 600 is hinged to a first end of the locking 300 at the medial position thereof. Therefore, when the connection lever 600 is rotated in the clockwise direction by actuation of the door lock switch rod 610, the first end of the locking link 300 is rotated downwards, thus maintaining the locked state of the vehicle door as explained in detail later.

The pawl lever 200 is rotatably mounted to the second portion of the base plate by the second rotating shaft 710, which is spaced apart from the first rotating shaft 110 by a predetermined distance.

As set forth above, the pawl lever returning spring is fitted over the second rotating shaft 710 of the pawl lever 200. The pawl lever returning spring functions to return the pawl lever 200 to its original position, at which the pawl lever 200 is locked to claw lever 100. In other words, after the pawl lever 200 has been rotated by the claw lever 100, when the force with which the pawl lever 200 is maintained in the rotated state is removed from the pawl lever 200, the pawl returning spring returns the pawl lever 200 to its original position.

The outside handle lever 700 is coupled to an outside handle through an outside handle rod 730 and thus rotated by the operation of the outside handle. For this, the outside handle lever 700 is rotatably mounted to the second portion of the base plate by the second rotating shaft 710. An outside handle lever returning spring is fitted over the second rotating shaft 710 to return the rotated outside handle lever 700 to its original position.

Furthermore, a vertical guide slot 720, which extends a predetermined length is formed through the outside handle lever 700 to guide a second end 310 of the locking link 300 such that the second end 310 of the locking link 300 is moved in a vertical direction as shown in FIG. 2. Therefore, when the first end of the locking link 300 is moved downwards by the rotation of the connection lever 600, the second end 310 of the locking link 300 is configured to be disposed at the lower end of the vertical guide slot 720 of the outside handle lever 700. Thus, the locking link 300 is moved to a locked position. In this state, the vehicle door maintains the locked state.

An open lever 800 is integrally formed on a portion of the outside handle lever 700 so that whenever the outside handle lever 700 rotates with respect to the second rotating shaft 710, the open lever 800 also rotates with respect to the second rotating shaft 710 at the same time.

The locking link 300 is constructed such that it is rotated in conjunction with the open lever 800. Particularly, an actuation end of the open lever 800 is disposed at a position corresponding to the upper end of the vertical guide slot 720 so that when the second end 310 of the locking link 300 is disposed at the upper end of the vertical guide slot 720, the locking link 300 can be rotated in the counterclockwise direction by the open lever 800 formed on the outside handle lever 700.

In detail, the locking link 300 includes a locking pin 750 in the medial position thereof. In the locking state, the second end 310 of the locking link 300 is disposed at lower end of the vertical guide slot 720 and the locking pin 750 is disposed on the pawl lever 200 so that the user cannot open the door by operating the outside handle.

However, in the case where the second end 310 of the locking link 300 is disposed at the upper end of the vertical guide slot 720, i.e., in the unlocked state of the vehicle door, the locking pin 750 moves upwards from the pawl lever 200. Accordingly when the outside handle lever 700 is rotated by the user, the open lever 800 is also rotated by the outside handle lever 700 in the counterclockwise direction.

Then, the locking link 300 is rotated by the rotation of the open lever 800 in the counterclockwise direction, so that the pawl lever 200 is released from the locking pin 750, the pawl lever 200 rotates in the counterclockwise direction by the pawl lever returning spring, and thus released from the claw lever 100.

Meanwhile, in the case where the second end 310 of the locking link 300 is disposed at the lower end of the vertical guide slot 720, i.e., in the unlocked state of the vehicle door, even though the outside handle lever 700 is rotated, the pawl lever 200 is not rotated because the open lever 800 is not brought into contact with the second end 310 of the locking link 300 and thus the locking pin 750 of the locking link 300 locks the pawl lever 200. Therefore, the locking of the pawl lever 200 to the claw lever 100 is maintained.

Particularly, the unlocking rod 500 are hinged to the third portion of the base plate so that when the vehicle door is closed in the locked state, the locking link 300 is moved to the unlocked position by the pawl rod 400 and the unlocking rod 500 so that even if a user places a vehicle key in the passenger compartment and closes the door which is in the locked state, the door can be prevented from being undesirably locked.

In detail, the pawl rod 400 is hinged at a first end thereof to the pawl lever 200 and coupled at a second end thereof to a first end of the unlocking rod 500. Here, a guide slot 520 is longitudinally formed through the first end of the unlocking rod 500. Thus, the second end of the pawl rod 400 is movable in the longitudinal direction of the first end of the unlocking rod 500.

In addition, a guide groove 740 is formed through the outside handle lever 700 so that the first end of the pawl rod 400, that is, the hinge shaft of the pawl rod 400, is moved along the guide groove 740. Therefore, when the pawl lever 200 is rotated, the hinge shaft of the pawl rod 400 is guided in a predetermined trajectory along the guide groove 740.

The unlocking rod 500 functions to move the locking link 300 upwards, which has been in the locked position, to the unlocked position when the pawl rod 400 is rotated by the rotation of the claw lever 100.

The unlocking rod 500 is hinged at a medial portion thereof to the third position of the base plate. The second end of the pawl rod 400 is coupled to the first end of the unlocking rod 500 so as to be movable through the guide hole 520 of the unlocking rod 500. A second end of the unlocking rod 500 is disposed adjacent to the vertical guide slot 720 of the outside handle lever 700.

When the first end of the unlocking rod 500 is moved downwards by the operation of the pawl rod 400, the unlocking rod 500 is rotated around the medial portion of the unlocking rod 500 which serves as a rotating shaft 510. Thus, the second end of the unlocking rod 500 is moved upwards. Hence, the locking link 300 which has been in the lower end of the vertical guide slot 720 of the handle lever 700 is moved towards the upper end of the vertical guide slot 720.

The operation and effect of various embodiments of the present invention having the above-mentioned construction will be explained herein below.

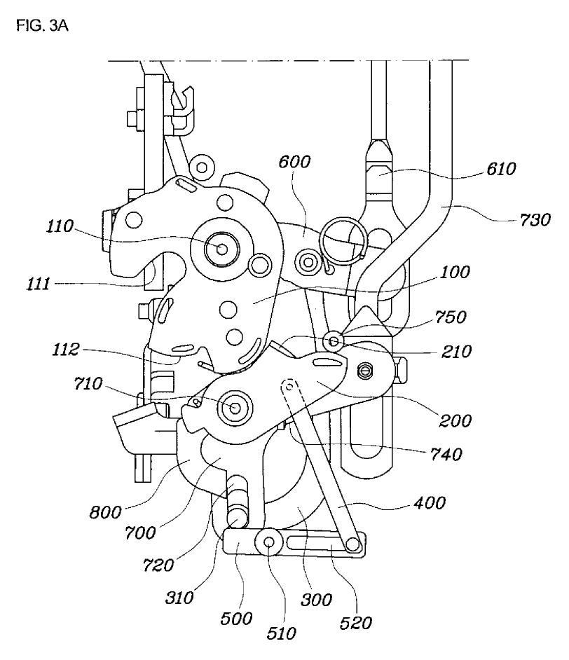

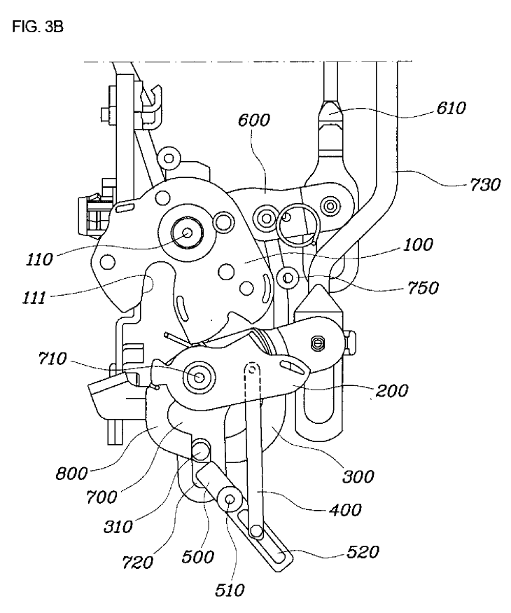

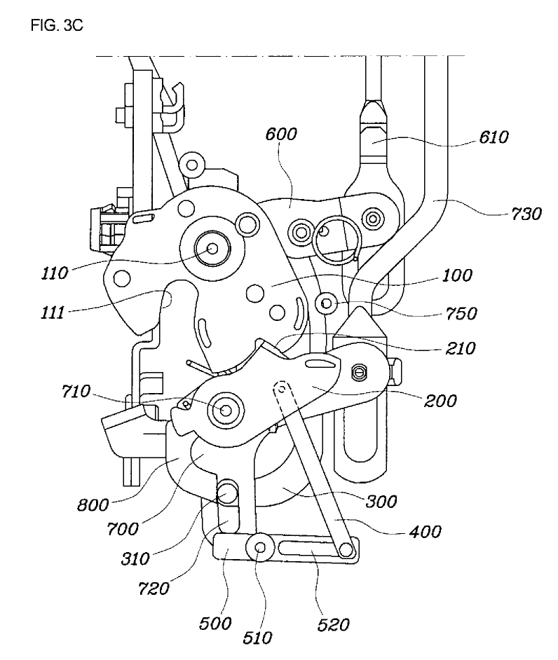

As shown in FIG. 3A, in the locked state of the door, that is, in the state in which the connection lever 600 has been rotated downwards by the door lock switch rod 610 and thus the locking link 300 is in the locked position. Furthermore the locking pin 750 is disposed on the pawl lever 200 and the pawl lever 200 is completely locked by the locking pin 750. In this configuration when the user leaves the vehicle and the door is closed, the claw lever 100 is rotated by the entrance of the striker.

As shown in FIG. 3B, when the pawl lever 200 is rotated in the clockwise direction by the rotation of the claw lever 100, the second end of the pawl rod 400 moves along the guide slot 520 of the unlocking rod 500 and rotates the unlocking rod 500. At this time, the second end of the unlocking rod 500 moves upwards and pushes the locking link 300 upwards such that the locking link 300 is moved upwards from the locked position to the unlocked position and at the same time the locking pin 750 moves upwards to unlock the pawl lever 200.

As shown in FIG. 3C, when the operation of closing the door is completed, the pawl lever 200 is rotated to its original position in a counterclockwise direction by the pawl lever returning spring as shown in FIG. 3C. Thus, the pawl lever 200 is locked to the claw lever 100. The pawl rod 400 and the unlocking rod 500 are also returned to their original positions.

In this state, when the user operates the outside handle to pull up the outside handle rod 730, the outside handle lever 700 is thus rotated in the counterclockwise direction, the open lever 800 is brought into contact with the second end 310 of the locking link 300 and is rotated in the counterclockwise direction along with the locking link 300. Therefore, the pawl lever 200 unlocked from the locking pin 750 is rotated by pawl lever returning spring, so that the door is opened.

As described above, in various embodiments of the present invention, even though a vehicle door is closed in the locked stated, the door is mechanically released from the locked state. Hence, the door is prevented from being undesirably locked, for example, even when a vehicle key is placed in the passenger compartment by a mistake of a user.

For convenience in explanation and accurate definition in the appended claims, the terms “upper”, “lower”, “upwards” and “downwards” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof It is intended that the scope of the invention be defined by the Claims appended hereto and their equivalents.

What is claimed is:

1. A door latch apparatus for vehicles, comprising:
a pawl lever hinged to a base plate to restrict a claw lever, the claw lever being rotated by an entrance of a striker;
a connection lever hinged to the base plate, the connection lever being rotated by an operation of a door lock switch rod;
an outside handle lever hinged to the base plate, the outside handle lever being rotated by an operation of an outside handle rod;
a locking link connected between the connection lever and the outside handle lever to releasably lock the pawl lever;
a pawl rod hinged at a first end thereof to the pawl lever; and
an unlocking rod coupled at a first end thereof to a second end of the pawl rod, the unlocking rod being hinged at a medial portion thereof to the base plate.

2. The door latch apparatus for vehicles as set forth in claim 1, further comprising:
an open lever hinged to the base plate, the open lever being pushed and rotated by the locking link to release the claw lever from the pawl lever.

3. The door latch apparatus for vehicles as set fort in claim 2, wherein when the pawl lever is rotated by the claw lever, the second end of the pawl rod pushes the first end of the unlocking rod, so that a second end of the unlocking rod is rotated, thus moving the locking link to an unlocked position.

4. The door latch apparatus for vehicles as set forth in claim 2, wherein
a first end of the locking link is hinged to the connection lever, and
a second end of the locking link is coupled to the outside handle lever so as to be movable upwards or downwards.

5. The door latch apparatus for vehicles as set forth in claim 4, wherein a first guide slot is formed through the first end of the unlocking rod so that the second end of the pawl rod is movable along the first guide slot in a longitudinal direction of the unlocking rod.

6. The door latch apparatus for vehicles as set forth in claim 4, wherein a second guide slot is formed through the outside handle lever to guide movement of a hinge shaft of the pawl rod when the pawl lever is rotated.

7. A passenger vehicle comprising the door latch apparatus for vehicles as set forth in claim 1.

8. A door latch apparatus for vehicles, comprising:
a base plate;
a claw lever pivotally coupled to the base plate at first position;
a pawl lever pivotally coupled to the base plate at second position to selectively restrict rotation of the claw lever, the claw lever being rotated by an entrance of a striker;
a connection lever, one end of which is pivotally coupled to the first position of the base plate and the other end of which is pivotally coupled to a door lock switch rod, the connection lever being rotated by an operation of the door lock switch rod;
an outside handle lever pivotally coupled to the second position, one end of the outside handle lever being coupled to and operated by an outside handle rod, wherein the outside handle lever includes an open lever;
a locking link, one end of which is pivotally coupled to the connection lever at a medial position thereof and the other end of which is slidably coupled to a second end of the outside handle lever, wherein the other end of the locking link is selectively engaged with the open lever of the outside handle lever to unlock the pawl lever;
a pawl rod hinged at one end thereof to the pawl lever; and
an unlocking rod, one end of which is coupled to the other end of the pawl rod and the other end of which is engaged with the other end of the locking link, the unlocking rod being hinged at a medial portion thereof to third position of the base plate.

9. The door latch apparatus for vehicles as set forth in claim 8, wherein the pawl lever is elastically biased toward the crawl lever by an elastic member.

10. The door latch apparatus for vehicles as set forth in claim 8, wherein the outside handle lever is elastically supported by an elastic member to maintain the original position thereof.

11. The door latch apparatus for vehicles as set forth in claim 8, wherein the locking link includes a locking pin at medial position thereof to selectively lock the pawl lever according to position of the locking link.

12. The door latch apparatus for vehicles as set forth in claim 8, wherein when the pawl lever is rotated by the claw lever, the other end of the pawl rod pushes the one end of the unlocking rod, so that the other end of the unlocking rod is rotated, thus moving the other end of the locking link to be engaged with the open lever to form an unlocked position.

13. The door latch apparatus for vehicles as set forth in claim 12, wherein a first guide slot is formed on the one end of the unlocking rod so that the other end of the pawl rod is slidably movable along the first guide slot in a longitudinal direction thereof.

14. The door latch apparatus for vehicles as set forth in claim 8, wherein a second guide slot is formed through the second end of the outside handle lever to receive the other end of the locking link.

15. A passenger vehicle comprising the door latch apparatus for vehicles as set forth in claim 8.
